(19) United States
(12) Patent Application Publication
(10) Pub. No.: US 2016/0165505 A1
(43) Pub. Date: Jun. 9, 2016

(54) COMMUNICATION SYSTEM, RADIO TERMINAL, COMMUNICATION METHOD, AND COMMUNICATION PROGRAM

(71) Applicant: NEC CORPORATION, Tokyo (JP)

(72) Inventor: Yoshinori SAIDA, Tokyo (JP)

(73) Assignee: NEC Corporation, Tokyo (JP)

(21) Appl. No.: 14/909,425

(22) PCT Filed: Jul. 10, 2014
(86) PCT No.: PCT/JP2014/003672

§ 371 Date: Feb. 1, 2016

(30) Foreign Application Priority Data
Aug. 5, 2013 (JP) 2013-162200

(51) Int. Cl. H04W 36/14; H04W 36/00; H04W 36/30

(52) U.S. Cl. CPC H04W 36/14; H04W 36/30; H04W 36/0038; H04W 88/06

(57) ABSTRACT

A radio terminal 100 capable of using a plurality of RATs includes a communication identification means 11 for identifying a type of communication made by the radio terminal 100, a connection control means 12 for controlling to use a communication route connected to which RAT as a communication route based on the communication type, and a route change means 13 for flowing communication through a designated RAT in response to an instruction of the connection control means 12. When a new communication route is connected to a RAT, the connection control means 12 instructs the route change means 13 to make user's data communication through an already-established RAT, and to flow communication required for NW connection establishment and quality measurement of a newly-connected communication route through a new RAT.

### TECHNICAL FIELD

The present invention relates to a communication control technique for radio terminals, and particularly to a communication control technique for radio terminals including a plurality of RATs (Radio Access Technology).

### BACKGROUND ART

In recent years, radio terminals including a plurality of RATs including Smartphone have increased. While making communication by use of a RAT connected to a network, when detecting other network set to be preferentially used to the connected network, such a radio terminal is controlled to switch to communication using the RAT connected to the other network.

For example, while making communication by use of a RAT connected to an already-connected first network (such as 3G (3rd Generation)), when detecting a second network (such as wireless LAN) set to be preferentially used to the first network, a conventional radio terminal is controlled to switch the communication route to the second network for communication using the RAT connected to the second network.

### CITATION LIST

### Patent Literature

PTL 1: International Publication No. 2012/144194

### SUMMARY OF INVENTION

### Technical Problem

However, in a radio terminal with the above structure, a switch processing is performed irrespective of communication quality of a switched network (the second network in the above case). Therefore, there is a problem that the radio terminal cannot acquire sufficient communication quality and thus data transmission or the like cannot be normally performed due to unstable communication after the communication is switched, or connection to the switched network is immediately disconnected and return to the previous network. Therefore, when a user is executing an application for making communication by use of the switched network, the use of the application may be prevented.

It is an object of the present invention to solve the above problem and to provide a communication system for confirming NW connection establishment and communication quality of a newly-detected network without giving an impact on user's data communication, a radio terminal, a communication method, and a communication program.

A radio terminal according to the present invention is a radio terminal capable of using a plurality of RATs, and the radio terminal includes: a communication identification means for identifying a type of communication made by the radio terminal; a connection control means for controlling to use a communication route connected to which RAT as a communication route based on the type of the communication; and a route change means for flowing communication through a designated RAT in response to an instruction of the connection control means, wherein when a new communication route is connected to a RAT, the connection control means instructs the route change means to make user's data communication by use of an already-established RAT and to flow communication required for NW connection establishment and quality measurement of a newly-connected communication route through a new RAT.

A communication method according to the present invention is a communication method by a radio terminal capable of using a plurality of RATs, and the method includes: a communication identification step in which a communication identification means provided in the radio terminal identifies a type of communication made by the radio terminal; a connection control step in which a connection control means provided in the radio terminal controls to use a communication route connected to which RAT as a communication route based on the type of the communication; and a route change step in which a route change means provided in the radio terminal flows communication through a designated RAT in response to an instruction of the connection control means, wherein in the connection control step, when a new communication route is connected to a RAT, the route change means is instructed to make user's data communication by use of an already-established RAT and to flow communication required for NW connection establishment and quality measurement of a newly-connected communication route through a new RAT.

A communication program according to the present invention is a communication program operating on a computer configuring a radio terminal capable of using a plurality of RATs, and the program causes: a communication identification means provided in the radio terminal to perform a communication identification processing of identifying a type of communication made by the radio terminal; a connection control means provided in the radio terminal to perform a connection control processing of controlling to use a communication route connected to which RAT as a communication route based on the type of the communication; and a route change means provided in the radio terminal to perform a route change processing of flowing communication through a designated RAT in response to an instruction of the connection control means, wherein in the connection control processing, when a new communication route is connected to a RAT, the route change means is instructed to make user's data communication by use of an already-established RAT and to flow communication required for NW connection establishment and quality measurement of a newly-connected communication route through a new RAT.

### Advantageous Effects of Invention

According to the present invention, it is possible to confirm NW connection establishment and communication quality of a newly-detected network without giving an impact on user's data communication.

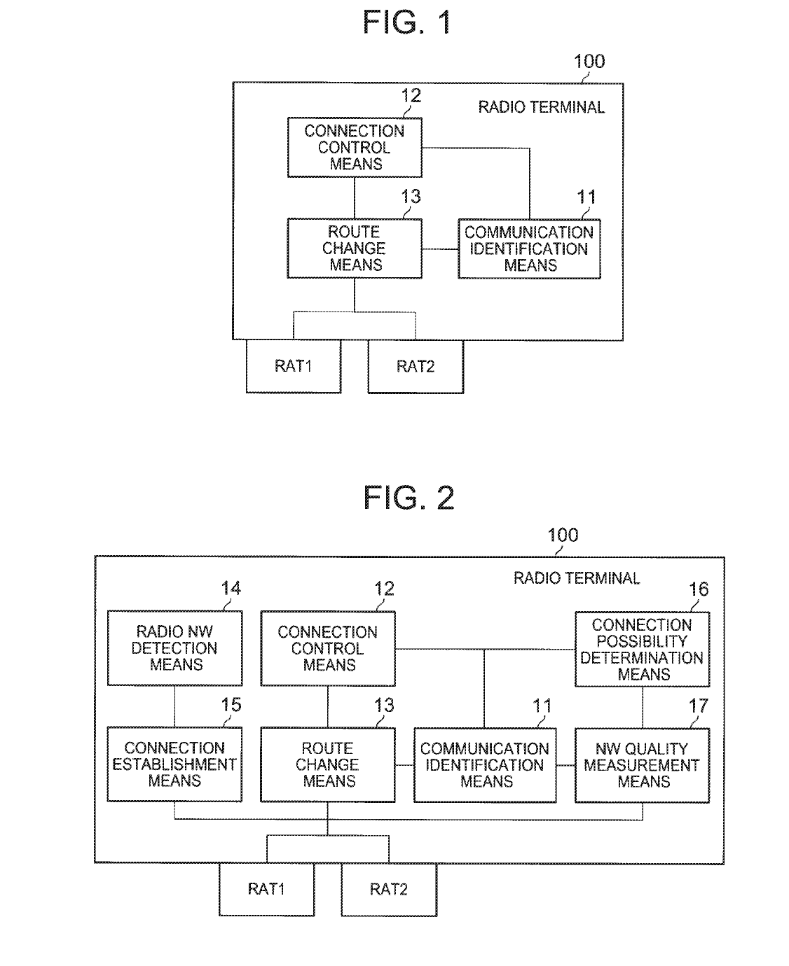

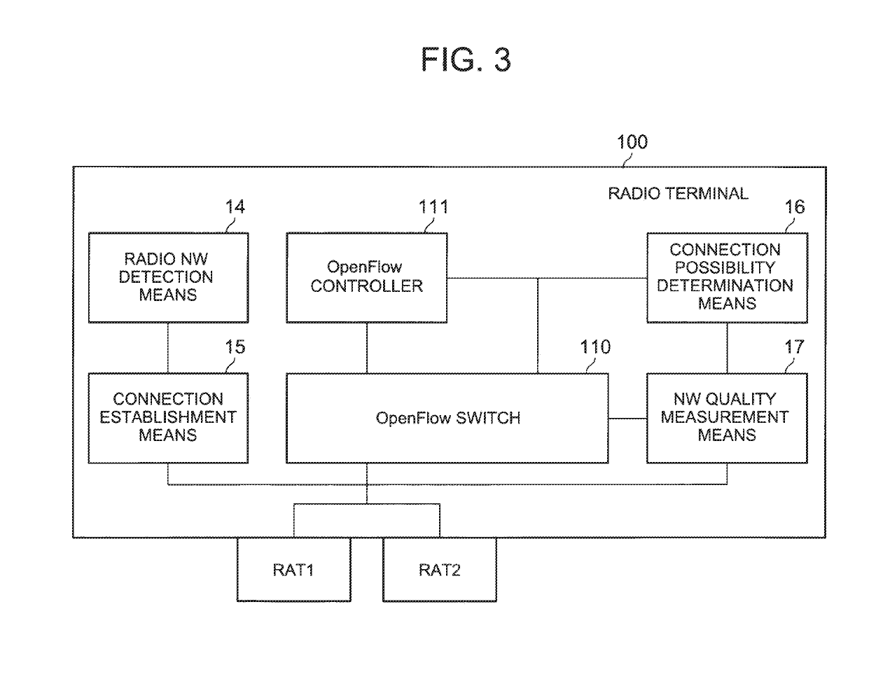

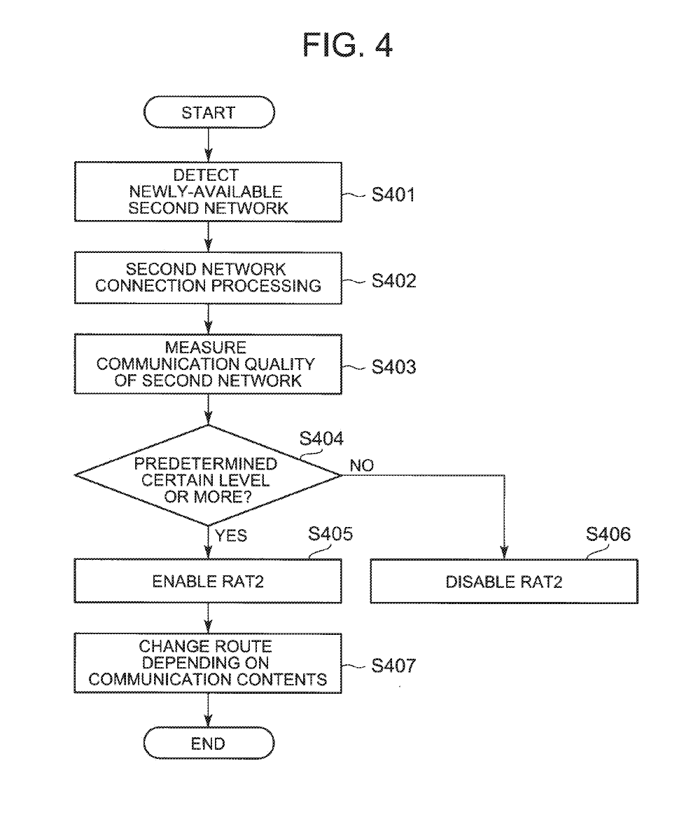

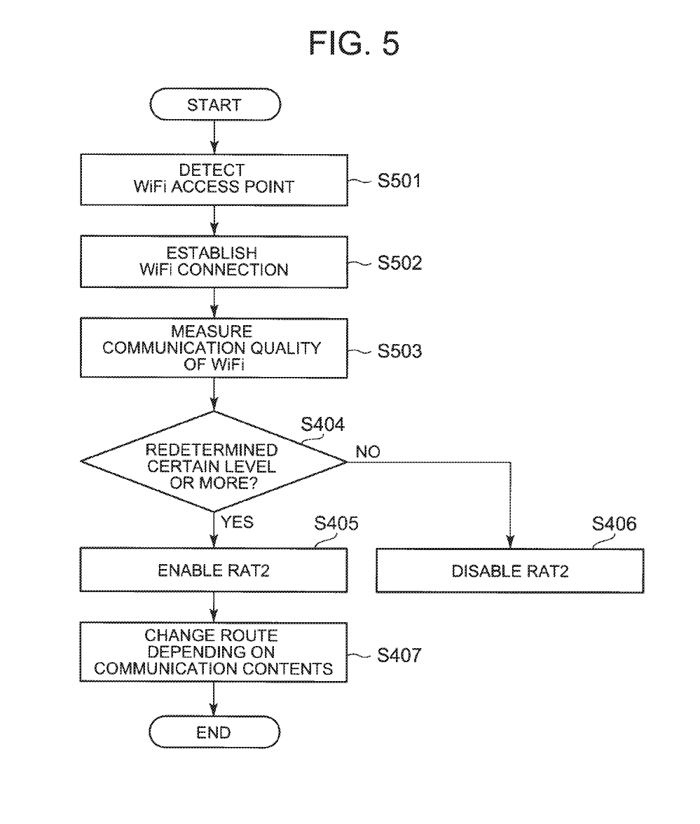

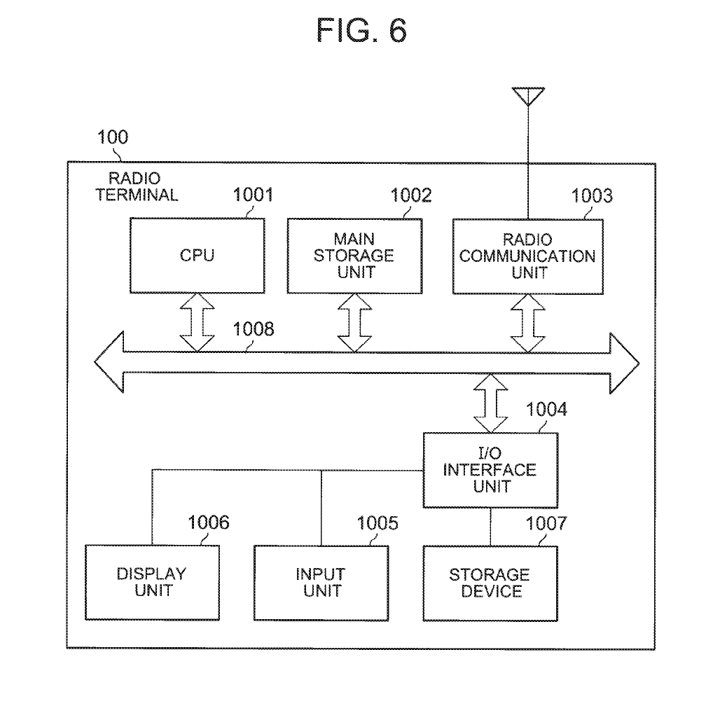

### BRIEF DESCRIPTION OF DRAWINGS

[FIG. 1] It depicts a block diagram illustrating a structure of a radio terminal according to a first exemplary embodiment of the present invention.

[FIG. 2] It depicts a block diagram illustrating a structure of the radio terminal according to a second exemplary embodiment of the present invention.

[FIG. 3] It depicts a block diagram illustrating a structure of the radio terminal according to the second exemplary embodiment of the present invention.

[FIG. 4] It depicts a flowchart illustrating the operations of the radio terminal according to the first exemplary embodiment of the present invention.

[FIG. 5] It depicts a flowchart illustrating the operations of the radio terminal according to a first example of the present invention.

[FIG. 6] It depicts a block diagram illustrating an exemplary hardware structure of the radio terminal according to the present invention.

### DESCRIPTION OF EMBODIMENTS

Exemplary embodiments according to the present invention will be described below in detail with reference to the accompanying drawings in order to clarify the above and other objects, features, and advantages of the present invention. Other technical problems, means for solving the technical problems, and operational effects thereof in addition to the object of the present invention will be made apparent with reference to the disclosed exemplary embodiments described below. Through all the drawings, like components are denoted with like reference numerals, and a description thereof will be omitted as appropriate.

### First Exemplary Embodiment

A first exemplary embodiment of the present invention will be described in detail with reference to the drawing.

FIG. 1 is a block diagram illustrating a structure of a radio terminal 100 according to the first exemplary embodiment of the present invention. With reference to FIG. 1, the radio terminal 100 includes a communication identification means 11, a connection control means 12, and a route change means 13.

The radio terminal 100 includes two RATs (RAT1 and RAT2), and the RATs (multi-RAT) are connected to NW IF (Network Interface), respectively. Herein, RAT is one type of mobile communication system, and is widely known to those skilled in the art, and thus a detailed description thereof will be omitted. FIG. 1 is exemplary and does not limit the system configuration, and the number of RATs is not limited to two.

The communication identification means 11 has a function of recognizing a type of communication (communication type) made by the radio terminal 100. The communication type may be a control signal or a data signal, and a control signal and a data signal flow through the same transmission path and are identified by the communication identification means 11.

Herein, control communication assumes communication related to a network connection processing, for example, but is not limited thereto. On the other hand, user's data communication assumes communication of actual data, such as communication of data which are image data or e-mails. Nevertheless, it is not limited thereto.

The connection control means 12 controls to use a network connected to which RAT as a communication route based on the communication type identified by the communication identification means 11.

The connection control means 12 makes user's data communication by use of an already-connected first network when a second network is newly connected to a RAT, and instructs the route change means to flow NW connection establishment communication and quality measurement communication of the second network through the second network.

### Advantages of First Exemplary Embodiment

According to the present exemplary embodiment, NW connection establishment and communication quality of a newly-detected network can be previously confirmed without giving an impact on user's data communication.

### Second Exemplary Embodiment

A second exemplary embodiment of the present invention will be described in detail with reference to the drawing.

FIG. 2 is a block diagram illustrating a structure of the radio terminal 100 according to the second exemplary embodiment of the present invention. FIG. 2 is exemplary, and does not limit the system configuration.

With reference to FIG. 2, the radio terminal 100 includes the communication identification means 11, the connection control means 12, the route change means 13, a radio NW detection means 14, a connection establishment means 15, a connection possibility determination means 16, and a NW quality measurement means 17. Though not illustrated, an application 10 operates on the radio terminal 100.

The radio terminal 100 includes two RATs (RAT1 and RAT2), and a plurality of RATs (Multi-RAT) are connected to NW IF, respectively. Herein, RAT is one type of mobile communication system and is widely known to those skilled in the art, and thus a detailed description thereof will be omitted.

The communication identification means 11 has a function of recognizing a type of communication made by the radio terminal 100. The communication type may be a control signal or a data signal, and a control signal and a data signal flow through the same transmission path, and are identified by the communication identification means 11.

Herein, control communication assumes communication for a network connection processing, for example, but is not limited thereto. On the other hand, user's data communication assumes communication of actual data, such as communication of data which are image data or e-mails. Nevertheless, it is not limited thereto.

The connection control means 12 has a function of determining which RAT to use as a communication route based on the communication type identified by the communication identification means 11.

The route change means 13 has a function of flowing communication through a designated RAT in response to an instruction of the connection control means 12.

The radio NW detection means 14 has a function of detecting a newly-available second network.

The connection establishment means 15 has a function of establishing connection with the second network detected by the radio NW detection means 14.

The NW quality measurement means 17 has a function of measuring communication quality of a second network after the second network is connected by the connection establishment means 15.

Some methods are assumed for confirming communication quality. For example, the NW quality measurement means 17 determines a degree of security based on security used for connection of WEP/WPA2 or the like, and can determine that the communication quality is insufficient when the degree of security is at less than a certain level. The NW quality measurement means 17 transmits a band measurement packet to a measurement counter-server via the second network and measures a communication band thereby to confirm quality.

Herein, it is assumed that a communication band for the currently-used first network is measured prior to the connection of the second network. Further, when the second network and the communication band are measured, a band measurement packet is flowed to each network via the route change means 13 under control of the connection control means 12.

The communication identification means 11 identifies user's data communication made by the radio terminal 100, the connection establishment communication for connection of the second network, and the quality measurement communication for network quality measurement. The connection control means 12 flows data through the first network or the second network by the route change means 13 depending on the identified communication type.

The connection possibility determination means 16 determines whether the communication quality of the second network measured by the NW quality measurement means 17 is at a predetermined certain level or more, and when the communication quality is at the predetermined certain level or more, enables the RAT connected with the second network. On the other hand, when the communication quality is at less than the certain level, the connection possibility determination means 16 disables the RAT connected with the second network.

When the RAT connected with the second network is enabled, a plurality of RATs may be made available together with the RAT of the first network, or the RAT of the first network may be disabled and the RAT of the second network may be enabled. When the RAT of the first network is disabled, the second network may be set to be preferentially used to the first network, for example.

Herein, the communication identification means 11 and the route change means 13 may be mounted in an OpenFlow switch 110. The connection control means 12 may be mounted in an OpenFlow controller 111. An exemplary structure using the OpenFlow switch 110 and the OpenFlow controller 111 is illustrated in FIG. 3. The OpenFlow technique is disclosed in Patent Literature 1 in detail, and thus a detailed description of the OpenFlow switch 110 and the OpenFlow controller 111 will be omitted. With the technique using OpenFlow, a plurality of RATs can be connected at the same time, and which RAT to use can be selectively controlled depending on a communication type.

### Description of Operations of Second Exemplary Embodiment

The operations of the radio terminal 100 according to the present exemplary embodiment will be described below in detail with reference to FIG. 4.

At first, the radio NW detection means 14 detects a second network while a first network is connected to the RAT1 (step S401).

Then, the connection establishment means 15 performs a processing of connecting a second network to the RAT2 (step S401). The connection establishment means 15 produces communication for connection establishment. The communication identification means 11 identifies a type of the communication, and the connection control means 12 instructs the route change means 13 to flow the communication through the unused RAT.

When the second network is connected, the two networks are made available, and the connection control means 12 flows all the communication through the first network by use of the route change means 13. This is because the communication quality of the second network is unknown at this time. As described below, the connection control means 12 controls to flow only the communication required for measuring communication quality of the network through the second network.

After the second network is connected, the NW quality measurement means 17 measures quality of the second network (step S403). When measuring a communication band of the second network, the NW quality measurement means 17 generates a band measurement packet thereby to produce communication. The communication identification means 11 identifies a communication type of the packet, and the connection control means 12 instructs the route change means 13 to flow the communication through the RAT2.

Then, the connection possibility determination means 16 determines whether to enable the RAT2. The connection possibility determination means 16 determines whether the communication quality of the second network measured by the NW quality measurement means 17 is at a predetermined certain level or more (step S404). When the communication quality is at the certain level or more (“YES” in step S404), the connection possibility determination means 16 enables the RAT2 (step S405). On the other hand, when the communication quality is at less than the predetermined certain level (“NO” in step S404), the connection possibility determination means 16 disables the RAT2 (step S406).

When the RAT2 is enabled, the connection control means 12 instructs the route change means 13 to use an optimum route for each communication depending on communication contents identified by the communication identification means 11 (step S407).

### First Example

The operations of FIG. 4 will be described below by use of a specific example.

### Description of Structure

A structure of the present example is the structure illustrated in FIG. 3. The present example will be described assuming that the first network already connected to the RAT1 is 3G and the newly-detected second network is WiFi.

### Description of Operations

The operations of the present example will be described with reference to the flowchart of FIG. 5.

While 3G is connected to the RAT1, the radio NW detection means 14 detects a WiFi access point (step S501).

Then, the connection establishment means 15 performs a WiFi connection establishment processing (step S501).

When WiFi connection is established, both networks 3G and WiFi are made available, and the connection control means 12 flows all the communication toward 3G by use of the OpenFlow switch 110. This is because the communication quality of WiFi is unknown at this time.

After WiFi connection is established, the NW quality measurement means 17 measures communication quality of WiFi (step S503). When measuring a communication band of WiFi, the NW quality measurement means 17 generates a band measurement packet thereby to produce communication. Then, the OpenFlow switch 110 identifies a communication type of the packet. Then, the OpenFlow controller 111 instructs the OpenFlow switch 110 to flow the communication through the RAT2.

When the band measurement packet is transmitted, a communication band of 3G may be measured prior to WiFi connection. When the OpenFlow switch 110 measures the band measurement packet after WiFi connection, the OpenFlow controller 111 instructs the OpenFlow switch 110 to flow only the band measurement packet toward WiFi. On the other hand, when 3G communication standby is also measured during WiFi connection, the OpenFlow switch 110 is used to divide the band measurement data to 3G on 3G measurement and to WiFi on WiFi measurement, thereby measuring both of them.

Then, the connection possibility determination means 16 determines whether to enable the RAT2. The connection possibility determination means 16 determines whether the communication quality of WiFi measured by the NW quality measurement means 17 is at a predetermined certain level or more (step S404), and when the communication quality is at the certain level or more (“YES” in step S404), enables the RAT2 (step S405). On the other hand, when the communication quality is at less than the predetermined certain level (“NO” in step S404), the connection possibility determination means 16 disables the RAT2 (step S406).

When the RAT2 is enabled, the OpenFlow controller 111 instructs the OpenFlow switch 110 to use an optimum route for each communication depending on communication contents identified by the OpenFlow switch 110 (step S407).

The communication contents assume communication sender application, communication destination server address, communication protocol (such as TCP or UDP), communication data type (such as text data, image data, or stream data), or the like, for example.

As exemplary control, for example, it is assumed that small-capacity communication or always-on connection communication (for e-mails or the like) are made in 3G, and large-capacity communication for animations or application update data is made in WiFi. A communication route with a higher degree of security may be used for communication with a party having a business address (such as working place or client company).

### Advantages of Second Exemplary Embodiment

According to the present exemplary embodiment, it is possible to previously confirm NW connection establishment and communication quality of a newly-detected network without giving an impact on user's data communication.

According to the present exemplary embodiment, when communication quality of a newly-detected network is at less than a certain level, the RAT connected with the network is disabled, and thus the communication can be prevented from being switched to the unstable network.

According to the present exemplary embodiment, communication quality of each network is measured thereby to divide each communication to an optimum communication route depending on communication contents.

An exemplary hardware structure of the radio terminal 100 according to the present exemplary embodiment will be described below with reference to FIG. 6. FIG. 6 is a block diagram illustrating an exemplary hardware structure of the radio terminal 100 according to the present invention.

With reference to FIG. 6, the radio terminal 100 according to the present exemplary embodiment has a similar hardware structure as typical cell phones, and includes a CPU (Central Processing Unit) 1001, a main storage unit 1002 configured of a memory such as RAM (Random Access Memory) and used as a data working area or a data temporary saving area, a radio communication unit 1003 for sending and receiving data via radio communication, an I/O interface unit 1004 connected to an input unit 1005, a display unit 1006, and a storage device 1007 and directed for sending and receiving data, and a system bus 1008 for mutually connecting the above components.

The operation of each function of the radio terminal 100 according to the present exemplary embodiment can be realized in hardware by mounting a circuit component as hardware component such as LSI (Large Scale Integration) incorporating a program therein. Each function of the radio terminal 100 according to the present exemplary embodiment can be realized in software by storing a program for the function in the storage device 1007, downloading the program into the main storage unit 1002, and executing the program in the CPU 1001.

The present invention has been described above with reference to the preferred exemplary embodiments, but the present invention is not necessarily limited to the above exemplary embodiments, and may be variously changed within the scope of its technical spirit.

Any combinations of the above components, or the expressions according to the present invention converted among methods, devices, systems, recording mediums, and computer programs may be effective as the forms of the present invention.

Various components according to the present invention do not necessarily need to be independent of each other, and a plurality of components may be formed as one member, one component may be formed of a plurality of members, a component may be part of other component, and part of a component may overlap with part of other component.

A plurality of procedures are described in order for the method and the computer program according to the present invention, but the described order does not limit the order in which the procedures are performed. Therefore, when performing the method and the computer program according to the present invention, the order of the procedures may be changed as far as it does not hinder their contents.

The procedures of the method and the computer program according to the present invention may not be individually performed at different timings. Therefore, one procedure may be performed while other procedure is being performed, or a timing to perform a procedure may partially or totally overlap with a timing to perform other procedure.

Part or all of the exemplary embodiments may be described as in the following supplementary notes, but is not limited thereto.

### Supplementary Note 1

A radio terminal capable of using a plurality of RATs, including:

a communication identification means for identifying a type of communication made by the radio terminal;

a connection control means for controlling to use a communication route connected to which RAT as a communication route based on the type of the communication; and

a route change means for flowing communication through a designated RAT in response to an instruction of the connection control means,

wherein when a new communication route is connected to a RAT, the connection control means instructs the route change means to make user's data communication by use of an already-established RAT and to flow communication required for NW connection establishment and quality measurement of a newly-connected communication route through a new RAT.

### Supplementary Note 2

The radio terminal according to supplementary note 1, including:

a NW quality measurement means for measuring communication quality of the new communication route; and

a connection possibility determination means for determining whether the communication quality is at a certain level or more, and when it is at the certain level or more, enabling the RAT connected with the new communication route.

### Supplementary Note 3

The radio terminal according to supplementary note 2,

wherein the NW quality measurement means outputs a band measurement packet for measuring communication quality of the new communication route,

the communication identification means identifies the band measurement packet, and

the connection control means instructs the route change means to flow the band measurement packet through the new communication route RAT based on the identification result of the communication identification means.

### Supplementary Note 4

The radio terminal according to supplementary note 2,

wherein the NW quality measurement means measures communication quality of the communication route based on a degree of security of the new communication route.

### Supplementary Note 5

The radio terminal according to any one of supplementary note 2 to supplementary note 4,

wherein when the RAT connected with the new communication route is enabled, the connection possibility determination means disables the already-established RAT.

### Supplementary Note 6

The radio terminal according to any one of supplementary note 1 to supplementary note 5, including:

a radio NW detection means for detecting the new communication route; and

a connection establishment means for establishing connection between the communication route detected by the radio NW detection means and an unused RAT.

### Supplementary Note 7

The radio terminal according to any one of supplementary note 2 to supplementary note 6,

wherein when the RAT connected with the new communication route is enabled, the connection control means instructs the route change means to select any RAT depending on a type of communication identified by the communication identification means, and to flow communication through the RAT.

### Supplementary Note 8

A communication method by a radio terminal capable of using a plurality of RATs, the method including:

a communication identification step in which a communication identification means provided in the radio terminal identifies a type of communication made by the radio terminal;

a connection control step in which a connection control means provided in the radio terminal controls to use a communication route connected to which RAT as a communication route based on the type of the communication; and

a route change step in which a route change means provided in the radio terminal flows communication through a designated RAT in response to an instruction of the connection control means,

wherein in the connection control step, when a new communication route is connected to a RAT, the route change means is instructed to make user's data communication by use of an already-established RAT and to flow communication required for NW connection establishment and quality measurement of a newly-connected communication route through a new RAT.

### Supplementary Note 9

The communication method according to supplementary note 8, including:

a NW quality measurement step in which a NW quality measurement means provided in the radio terminal measures communication quality of the new communication route; and

a connection possibility determination step in which a connection possibility determination means provided in the radio terminal determines whether the communication quality is at a certain level or more, and when it is at the certain level or more, enables the RAT connected with the new communication route.

### Supplementary Note 10

The communication method according to supplementary note 9, including:

the NW quality measurement step of outputting a band measurement packet for measuring communication quality of the new communication route,

the communication identification step of identifying the band measurement packet, and

the connection control step of instructing the route change means to flow the band measurement packet through the new communication route RAT based on the identification result in the communication identification step.

### Supplementary Note 11

The communication method according to supplementary note 9, including:

the NW quality measurement step of measuring communication quality of the communication route based on a degree of security of the new communication route.

### Supplementary Note 12

The communication method according to any one of supplementary note 9 to supplementary note 11, including:

the connection possibility determination step of, when the RAT connected with the new communication route is enabled, disabling the already-established RAT.

### Supplementary Note 13

The communication method according to any one of supplementary note 8 to supplementary note 12, including:

a radio NW detection step in which a radio NW detection means provided in the radio terminal detects the new communication route; and

a connection establishment step in which a connection establishment means provided in the radio terminal establishes connection between the communication route detected in the radio NW detection step and an unused RAT.

### Supplementary Note 14

The communication method according to any one of supplementary note 9 to supplementary note 13, including:

the connection control step of, when the RAT connected with the new communication route is enabled, instructing the route change means to select any RAT depending on a type of communication identified in the communication identification step, and to flow communication through the RAT.

### Supplementary Note 15

A communication program operating on a computer configuring a radio terminal capable of using a plurality of RATs, the program causing:

a communication identification means provided in the radio terminal to perform a communication identification processing of identifying a type of communication made by the radio terminal;

a connection control means provided in the radio terminal to perform a connection control processing of controlling to use a communication route connected to which RAT as a communication route based on the type of the communication; and

a route change means provided in the radio terminal to perform a route change processing of flowing communication through a designated RAT in response to an instruction of the connection control means,

wherein in the connection control processing, when a new communication route is connected to a RAT, the route change means is instructed to make user's data communication by use of an already-established RAT and to flow communication required for NW connection establishment and quality measurement of a newly-connected communication route through a new RAT.

### Supplementary Note 16

The communication program according to supplementary note 15, the program causing:

a NW quality measurement means provided in the radio terminal to perform a NW quality measurement processing of measuring communication quality of the new communication route; and

a connection possibility determination means provided in the radio terminal to perform a connection possibility determination step of determining whether the communication quality is at a certain level or more, and when it is at the certain level or more, enabling the RAT connected with the new communication route.

### Supplementary Note 17

The communication program according to supplementary note 16, the program for causing a computer to perform:

the NW quality measurement processing of outputting a band measurement packet for measuring communication quality of the new communication route,

the communication identification processing of identifying the band measurement packet, and

the connection control processing of instructing the route change means to flow the band measurement packet through the new communication route RAT based on the identification result in the communication identification processing.

### Supplementary Note 18

The communication program according to supplementary note 16, the program for causing a computer to perform:

the NW quality measurement processing of measuring communication quality of the communication route based on a degree of security of the new communication route.

### Supplementary Note 19

The communication program according to any one of supplementary note 16 to supplementary note 18, the program for causing a computer to perform:

the connection possibility determination processing of, when the RAT connected with the new communication route is enabled, disabling the already-established RAT.

### Supplementary Note 20

The communication program according to any one of supplementary note 15 to supplementary note 19, the program for causing:

a radio NW detection means provided in the radio terminal to perform a radio NW detection processing of detecting the new communication route; and

a connection establishment means provided in the radio terminal to perform a connection establishment processing of establishing connection between the communication route detected in the radio NW detection processing and an unused RAT.

### Supplementary Note 21

The communication program according to any one of supplementary note 16 to supplementary note 20, the program for causing a computer to perform:

the connection control processing of, when the RAT connected with the new communication route is enabled, instructing the route change means to select any RAT depending on a type of communication identified in the communication identification processing, and to flow communication through the RAT.

The present invention has been described above with reference to the exemplary embodiments and the example, but the present invention is not limited to the exemplary embodiments and the example. The structure or details of the present invention may be variously changed within the scope of the present invention understandable by those skilled in the art.

The present application claims the priority based on Japanese Patent Application No. 2013-162200 filed on Aug. 5, 2013, the disclosure of which is all incorporated herein by reference.

### REFERENCE SIGNS LIST

11 Communication identification means

12 Connection control means

13 Route change means

14 Radio NW detection means

15 Connection establishment means

16 Connection possibility determination means

17 NW quality measurement means

100 Radio terminal

110 OpenFlow switch

111 OpenFlow controller

1001 CPU

1002 Main storage unit

1003 Communication unit

1004 I/O interface unit

1005 Input device

1006 Output device

1007 Storage device

1008 System bus

1. A radio terminal capable of using a plurality of RATs, comprising:
a communication identification unit which identifies unit which identifies a type of communication made by the radio terminal;
a connection control unit which controls to use a communication route connected to which RAT as a communication route based on the type of the communication; and
a route change unit which flows communication through a designated RAT in response to an instruction of the connection control unit,
wherein when a new communication route is connected to a RAT, the connection control unit, instructs the route change unit, to make user's data communication by use of an already-established RAT and to flow communication required for NW connection establishment and quality measurement of a newly-connected communication route through a new RAT.

2. The radio terminal according to claim 1, comprising:
a NW quality measurement unit which measures communication quality of the new communication route; and
a connection possibility determination unit which determines whether the communication quality is at a certain level or more, and when it is at the certain level or more, enabling the RAT connected with the new communication route.

3. The radio terminal according to claim 2,
wherein the NW quality measurement unit outputs a band measurement packet for measuring communication quality of the new communication route,
the communication identification unit identifies the band measurement packet, and
the connection control unit instructs the route change unit to flow the band measurement packet through the new communication route RAT based on the identification result of the communication identification unit.

4. The radio terminal according to claim 2,
wherein the NW quality measurement unit measures communication quality of the communication route based on a degree of security of the new communication route.

5. The radio terminal according to claim 2,
wherein when the RAT connected with the new communication route is enabled, the connection possibility determination unit disables the already-established RAT.

6. The radio terminal according to claim 1. comprising:
a radio NW detection unit which detects the new communication route; and
a connection establishment unit which establishes unit which establishes connection between the communication route detected by the radio NW detection unit and an unused RAT.

7. The radio terminal according to claim 2,
wherein when the RAT connected with the new communication route is enabled, the connection control unit instructs the route change unit to select any RAT depending on a type of communication identified by the communication identification unit, and to flow communication through the RAT.

8. A communication method by a radio terminal capable of using a
plurality of RATs, the method comprising:
a communication identification unit provided in the radio terminal identifies a type of communication made by the radio terminal;
a connection control unit provided in the radio terminal controls to use a communication route connected to which RAT as a communication route based on the type of the communication; and
a route change unit provided in the radio terminal flows communication through a designated RAT in response to an instruction of the connection control unit,
wherein, when a new communication route is connected to a RAT, the route change unit is instructed to make user's data communication by use of an already-established RAT and to flow communication required for NW connection establishment and quality measurement of a newly-connected communication route through a new RAT.

9. The communication method according to claim 8, comprising:
a NW quality measurement unit provided in the radio terminal measures communication quality of the new communication route; and
a connection possibility determination unit provided in the radio terminal determines whether the communication quality is at a certain level or more, and when it is at the certain level or more, enables the RAT connected with the new communication route.

10. A non-transitory computer readable information recording medium storing a communication program operating on a computer configuring a radio terminal capable of using a plurality of RATs that, when executed by a processor, performs a method for:
a communication identification unit provided in the radio terminal identifies a type of communication made by the radio terminal;
a connection control unit provided in the radio terminal controls to use a communication route connected to which RAT as a communication route based on the type of the communication; and
a route change unit provided in the radio terminal flows communication through a designated RAT in response to an instruction of the connection control unit,
wherein, when a new communication route is connected to a RAT, the route change unit is instructed to make user's data communication by use of an already-established RAT and to flow communication required for NW connection establishment and quality measurement of a newly-connected communication route through a new RAT.

11. The radio terminal according to claim 3,
wherein when the RAT connected with the new communication route is enabled, the connection possibility determination unit disables the already-established RAT.

12. The radio terminal according to claim 4,
wherein when the RAT connected with the new communication route is enabled, the connection possibility determination unit disables the already-established RAT.

13. The radio terminal according to claim 2, comprising:
a radio NW detection unit which detects the new communication route; and
a connection establishment unit which establishes connection between the communication route detected by the radio NW detection unit and an unused RAT.

14. The radio terminal according to claim 3, comprising:
a radio NW detection unit which detects the new communication route; and
a connection establishment unit which establishes connection between the communication route detected by the radio NW detection unit and an unused RAT.

15. The radio terminal according to claim 4, comprising:
a radio NW detection unit which detects the new communication route; and
a connection establishment unit which establishes connection between the communication route detected by the radio NW detection unit and an unused RAT.

16. The radio terminal according to claim 5, comprising:
a radio NW detection unit which detects the new communication route; and
a connection establishment unit which establishes connection between the communication route detected by the radio NW detection unit and an unused RAT.

17. The radio terminal according to claim 3,
wherein when the RAT connected with the new communication route is enabled, the connection control unit instructs the route change unit to select any RAT depending on a type of communication identified by the communication identification unit, and to flow communication through the RAT.

18. The radio terminal according to claim 4,
wherein when the RAT connected with the new communication route is enabled, the connection control unit instructs the route change unit to select any RAT depending on a type of communication identified by the communication identification unit, and to flow communication through the RAT.

19. The radio terminal according to claim 5,
wherein when the RAT connected with the new communication route is enabled, the connection control unit instructs the route change unit to select any RAT depending on a type of communication identified by the communication identification unit, and to flow communication through the RAT.

20. The radio terminal according to claim 6,
wherein when the RAT connected with the new communication route is enabled, the connection control unit instructs the route change unit to select any RAT depending on a type of communication identified by the communication identification unit, and to flow communication through the RAT.
